(19) United States
(12) Patent Application Publication
(10) Pub. No.: US 2013/0040485 A1
(43) Pub. Date: Feb. 14, 2013

(54) ELECTRICAL CONNECTOR INCLUDING GUIDANCE AND LATCH ASSEMBLY

(71) Applicant: Hung Viet Ngo, Austin, TX (US)

(72) Inventor: Hung Viet Ngo, Austin, TX (US)

(21) Appl. No.: 13/571,737

(22) Filed: Aug. 10, 2012

Related U.S. Application Data
(60) Provisional application No. 61/523,000, filed on Aug. 12, 2011.

(51) Int. Cl. H01R 13/627

(52) U.S. Cl. 439/350

(57) ABSTRACT

An electrical connector assembly includes first and second electrical connectors that include complementary guidance members and complementary latch members that engage when the first and second electrical connectors are mated.

### CROSS-REFERENCE TO RELATED APPLICATIONS

This claims the benefit of U.S. Patent Application Ser. No. 61/523,000, filed Aug. 12, 2011, the disclosure of which is hereby incorporated by reference as if set forth in its entirety herein.

### BACKGROUND

Electrical connector assemblies generally include a pair of electrical connectors that are configured to be mounted to a complementary electrical device, such as a printed circuit board, cable assembly, or the like, and are configured to be mated to each other so as to place the complementary electrical devices in electrical communication with each other. For instance, the electrical connectors can include a plurality of electrical contacts, which can include electrical signal contacts that carry and transmit electrically conductive paths for electrical communications data signals, and/or electrical power contacts that carry and transmit electrical power.

The electrical connectors can include latch assemblies that are designed to reliably secure the electrical connectors to each other when mated.

### SUMMARY

In accordance with one embodiment, an electrical connector is configured to mate with a complementary electrical connector. The electrical connector includes a connector housing and a plurality of electrical contacts that are supported by the connector housing. The plurality of electrical contacts is configured to mate with electrical contacts of the complementary electrical connector at a mating interface. The electrical connector can include a guidance member that is configured to engage a complementary guidance member of the complementary electrical connector so as to align the electrical connector with the complementary electrical connector. The electrical connector can further include a latch member that is carried by the guidance member. The latch member is configured to engage a latch member of the complementary electrical connector so as to secure the electrical connector and the complementary electrical connector when the electrical connector is mated with the complementary electrical connector.

### BRIEF DESCRIPTION OF THE DRAWINGS

The foregoing summary, as well as the following detailed description of the preferred embodiments of the application, will be better understood when read in conjunction with the appended drawings. For the purposes of illustration, there are shown in the drawings preferred embodiments. It should be understood, however, that the instant application is not limited to the precise arrangements and/or instrumentalities illustrated in the drawings, in which:

FIG. 1A is a perspective view of an electrical connector assembly including a first electrical connector mounted to a first complementary electrical device, and a second electrical connector mounted to a complementary electrical device;

FIG. 1B is a perspective view of the first electrical connector illustrated in FIG. 1A, shown mounted to the first complementary electrical device;

FIG. 1C is another perspective view of the first electrical connector illustrated in FIG. 1A, shown mounted to the first complementary electrical device;

FIG. 1D is a perspective view of the second electrical connector illustrated in FIG. 1A, shown mounted to the second complementary electrical device;

FIG. 2A is a perspective view of a power contact assembly of the first electrical connector;

FIG. 2B is a perspective view of a portion of the power contact assembly illustrated in FIG. 2A;

FIG. 2C is a perspective view of a signal contact assembly of the first electrical connector;

FIG. 2D is a perspective view of a portion of the signal contact assembly illustrated in FIG. 2C;

FIG. 3A is an enlarged perspective view of a portion of the electrical connector assembly illustrated in FIG. 1A, showing a latch system and a guidance system;

FIG. 3B is an enlarged perspective view of a portion of the first electrical connector, showing a first guidance member and a first latch member of the latch and guidance systems, respectively;

FIG. 3C is an enlarged perspective view of a portion of the second electrical connector showing a second guidance member configured to engage the first guidance member illustrated in FIG. 3B, and a second latch member configured to engage the first latch member illustrated in FIG. 3A; and

FIG. 4 is a sectional side elevation view of the electrical connector assembly illustrated in FIG. 1A, but showing the first electrical connector mounted to a printed circuit board, and further showing the second electrical connector constructed as a right-angle connector.

### DETAILED DESCRIPTION

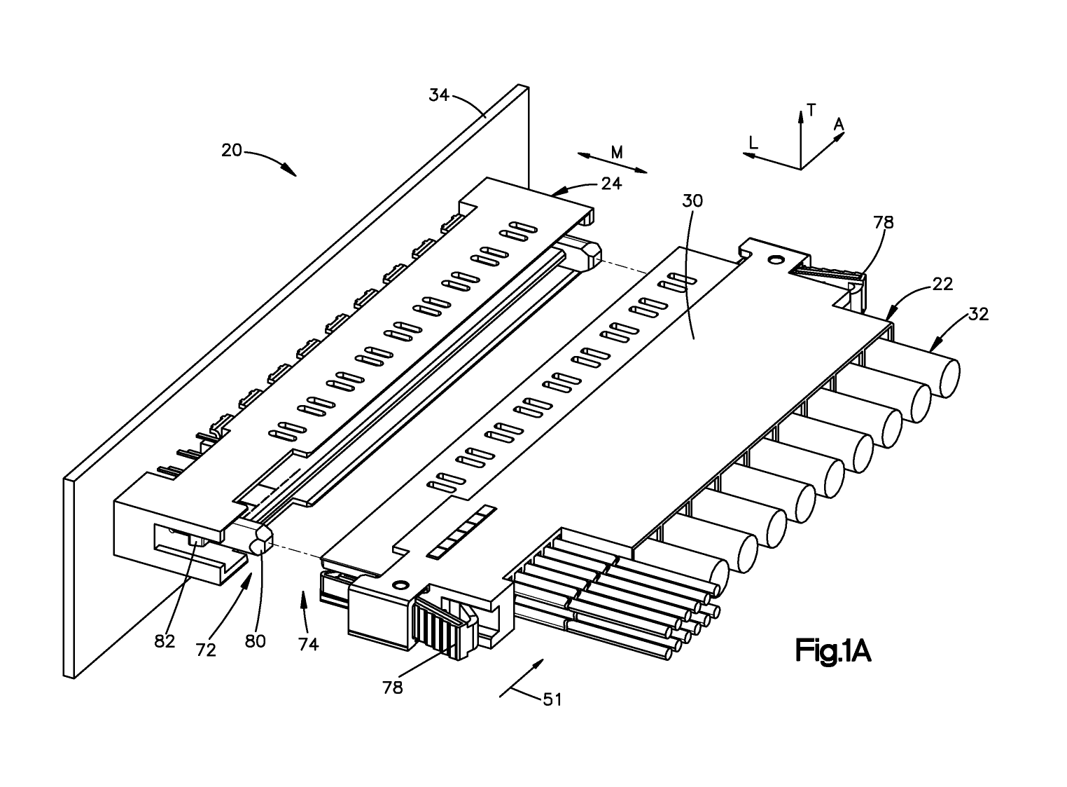

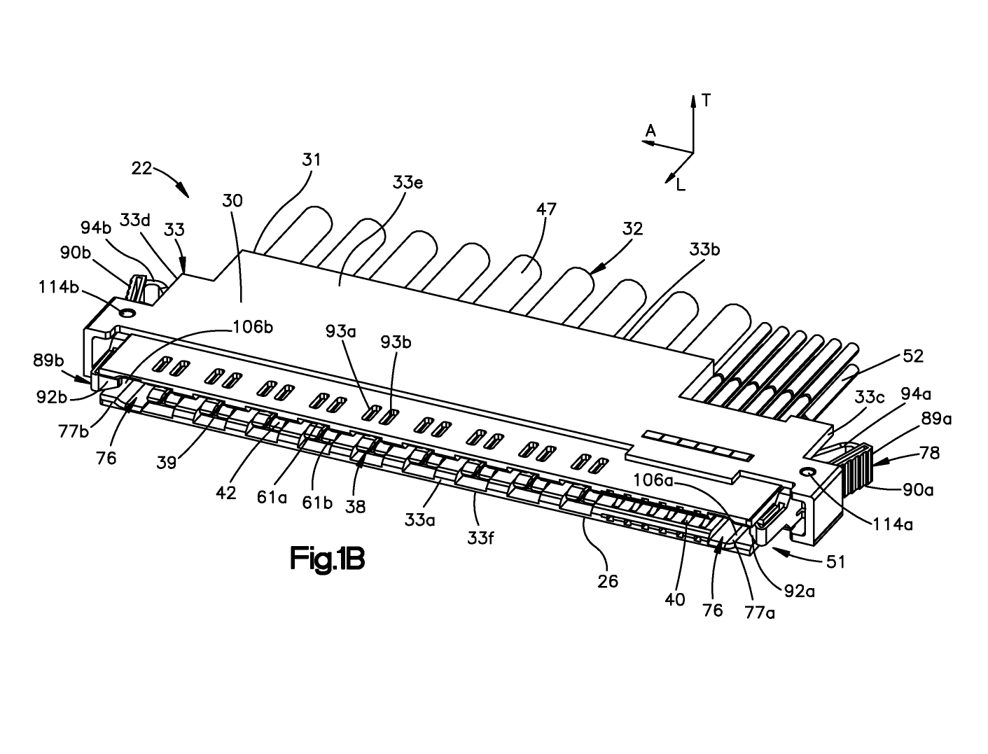

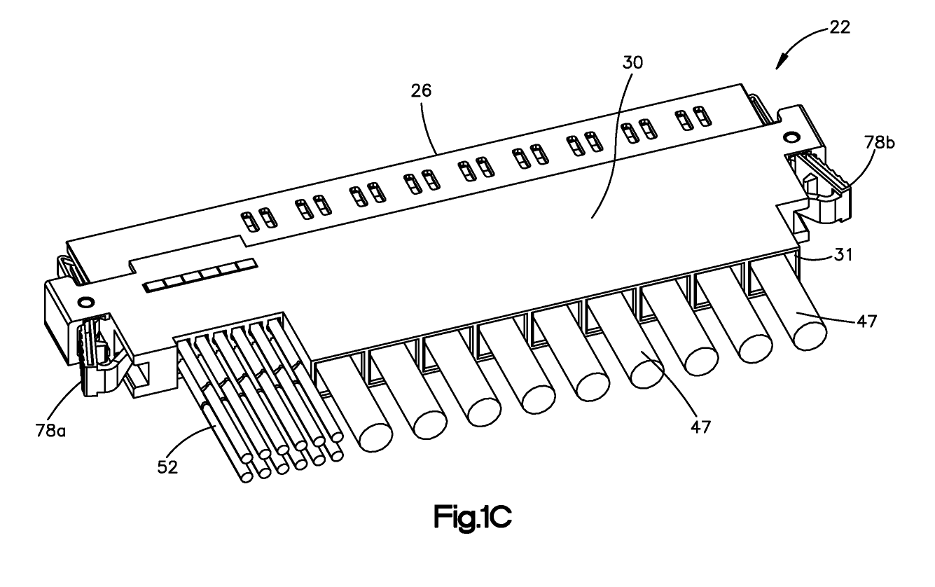

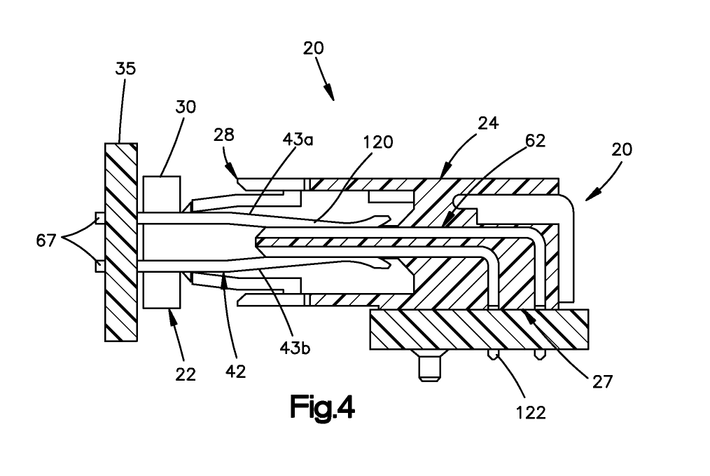

One aspect of the present disclosure provides a retention assembly that is configured to guide first and second electrical connectors to a mated configuration, and to physically secure first and second electrical connectors when in the mated configuration. Referring to FIGS. 1A-1D, an electrical connector assembly 20 constructed in accordance with one embodiment includes a first electrical connector 22 and a second electrical connector 24 that are configured to be mated to each other, and mounted to respective first and second complementary electrical devices. For example, in accordance with the illustrated embodiment, the first electrical connector 22 can be configured as an electrical cable connector that is configured to be mounted to a cable assembly 32 that can include a plurality of electrically conductive cables including at least one or both of power cables 47 and signal cables 52. The second electrical connector 24 is configured to be mounted to a substrate 34, which can be configured as a printed circuit board, in accordance with the illustrated embodiment. In accordance with an alternative embodiment illustrated in FIG. 4, the first complementary electrical device can be configured as a substrate 35, such as a printed circuit board.

The first electrical connector 22 includes a dielectric or electrically insulative first connector housing 30 and a first plurality of electrical contacts 38 that are supported by the first connector housing 30. Similarly, the second electrical connector 24 includes a dielectric or electrically insulative second connector housing 60 and a second plurality of electrical contacts 62 that are supported by the second connector housing 60. The first electrical connector 22 defines a mounting interface 31 that is configured to be mounted onto the cable assembly 32, thereby placing the first plurality of electrical contacts 38 in electrical communication with the cable assembly 32. The second electrical connector 24 further defines a mounting interface 27 that is configured to be mounted onto the substrate 34.

The first electrical connector 22 further defines a mating interface 26, and the second electrical connector 24 similarly defines a mating interface 28. The first and second electrical connectors 22 and 24 are configured to mate with each other at their respective mating interfaces 26 and 28, thereby placing the first plurality of electrical contacts 38 of the first electrical connector 22 in electrical communication with the second plurality of electrical contacts 62 of the second electrical connector 24. As will be described in more detail below, the electrical connector assembly 20 can include a guidance assembly 72 and an attachment assembly 74, which can be configured as a latch assembly. For instance, the first electrical connector 22 can include a first guidance member 76 and a first attachment member 78, and the second electrical connector 24 can include a second guidance member 80 and a second attachment member 82. Thus, the guidance assembly 72 can include the first guidance member 76 and the second guidance member that are configured to mate with each other so as to align the first connector housing 30 with the second connector housing 60 so that the first and second electrical connectors 22 and 24 can be mated by moving at least one of the first and second electrical connectors 22 and 24 relative to the other of the first and second electrical connectors 22 and 24 substantially along the longitudinal direction L. The attachment assembly 74 can include the first attachment member 78 and the second attachment member 82 which can mate with each other so as to secure, for instance removably secure, the first connector housing 30 to the second connector housing 60 when the first and second electrical connectors 22 and 24 when mated.

Various structures are described herein as extending horizontally along a longitudinal direction “L” and lateral direction “A” that is substantially perpendicular to the longitudinal direction L, and vertically along a transverse direction “T” that is substantially perpendicular to the longitudinal and lateral directions L and A, respectively. As illustrated, the longitudinal direction “L” extends along a forward/rearward direction of the electrical connector assembly 20, and defines a mating direction M along which one or both of the first and second electrical connectors 22 and 24 are moved relative to the other so as to mate with the other electrical connector. The lateral direction “A” extends along a width of each of the first and second electrical connectors 22 and 24, respectively, and the transverse direction “T” extends along a height of each of the first and second electrical connectors 22 and 24. Thus, unless otherwise specified herein, the terms “lateral,” “longitudinal,” and “transverse” are used to describe the orthogonal directional components of various components. The terms “inboard” and “inner,” and “outboard” and “outer” and like terms when used with respect to a specified directional component are intended to refer to directions along the directional component toward and away from the center of the apparatus being described.

It should be appreciated that while the longitudinal and lateral directions are illustrated as extending along a horizontal plane, and that the transverse direction is illustrated as extending along a vertical plane, the planes that encompass the various directions may differ during use, depending, for instance, on the orientation of the various components. Accordingly, the directional terms “vertical” and “horizontal” are used to describe the electrical connector assembly 20 and its components as illustrated merely for the purposes of clarity and convenience, it being appreciated that these orientations may change during use.

The first connector housing 30 includes a housing body 33 that defines a front end 33a and an opposed rear end 33b spaced from the front end 33a along the longitudinal direction L, first and second opposed sides 33c and 33d that are spaced from each other along the lateral direction A, and a top end 33e and an opposed bottom end 33f that is spaced from the top end 33e along the transverse direction T. The front end 33a of the housing body 33 can define the mating interface 26 of the first electrical connector 22, and the rear end 33b can define the mounting interface 31 of the first electrical connector 22. Accordingly, the mating interface 26 and the mounting interface 31 are oriented substantially parallel to each other in accordance with the illustrated embodiment, and the first electrical connector 22 can be referred to as a vertical electrical connector. It should be appreciated, however, that the first electrical connector can alternatively be a right-angle connector, whereby the mating interface 26 and the mounting interface 31 are oriented substantially perpendicular to each other.

With continuing reference to FIGS. 1A-D, the first plurality of electrical contacts 38 of the first electrical connector 22 can include at least one electrical signal contact 40 such as a plurality of electrical signal contacts 40, and at least one electrical power contact 42 such as a plurality of electrical power contacts 42. In accordance with the illustrated embodiment, the electrical signal contacts 40 are disposed adjacent the first side 33c, and the electrical power contacts 42 are disposed adjacent the second side 33c. Accordingly, the electrical signal contacts 40 can be disposed between the electrical power contacts 42 and the first side 33c, and the electrical power contacts 42 can be disposed between the electrical signal contacts 40 and the second side 33d. In accordance with alternative embodiments, the first electrical connector can be devoid of electrical signal contacts 40, such that the first plurality of electrical contacts 38 includes only electrical power contacts 42.

The first plurality of electrical contacts 38 can define mating ends 39 that are configured to mate with the complementary mating ends 120 of the second plurality of electrical contacts 62 of the second electrical connector 24 so as to mate the first electrical connector 22 with the second electrical connector 24. The mating ends 39 of the first plurality of electrical contacts 38 can be arranged in first and second rows 61a and 61b that are spaced from each other along the transverse direction T, so as to define a gap 63 that extends along the transverse direction T between the first row 61a and the second row 61b. Each of the first and second rows 61a and 61b extends along a row direction 51, which can be the lateral direction A in accordance with the illustrated embodiment. The front end 33a of the housing body 33 can define a receptacle that is configured to receive a portion of the second electrical connector 24 that carries the mating ends 120 of the second plurality of the second plurality of electrical contacts 62 when the first and second electrical connectors 22 and 24 are mated, such that the gap 63 receives the mating ends of the second plurality of electrical contacts 62, thereby placing the first plurality of electrical contacts 38 and 62 in electrical communication with each other.

Accordingly, the first electrical connector 22 can be referred to as a receptacle connector in accordance with the illustrated embodiment, whereby the corresponding electrical signal contacts 40 and electrical power contacts 42 are configured to receive the second plurality of electrical contacts 62 of the second electrical connector 24 so as to mate the first electrical connector 22 with the second electrical connector 24. It should be appreciated, however, that the first electrical connector 22 can alternatively be configured as a header or plug connector, whereby the first plurality of electrical contacts 38 are configured to be received by the second plurality of electrical contacts 62 of the second electrical connector 24 so as to mate the first electrical connector 22 to the second electrical connector 24.

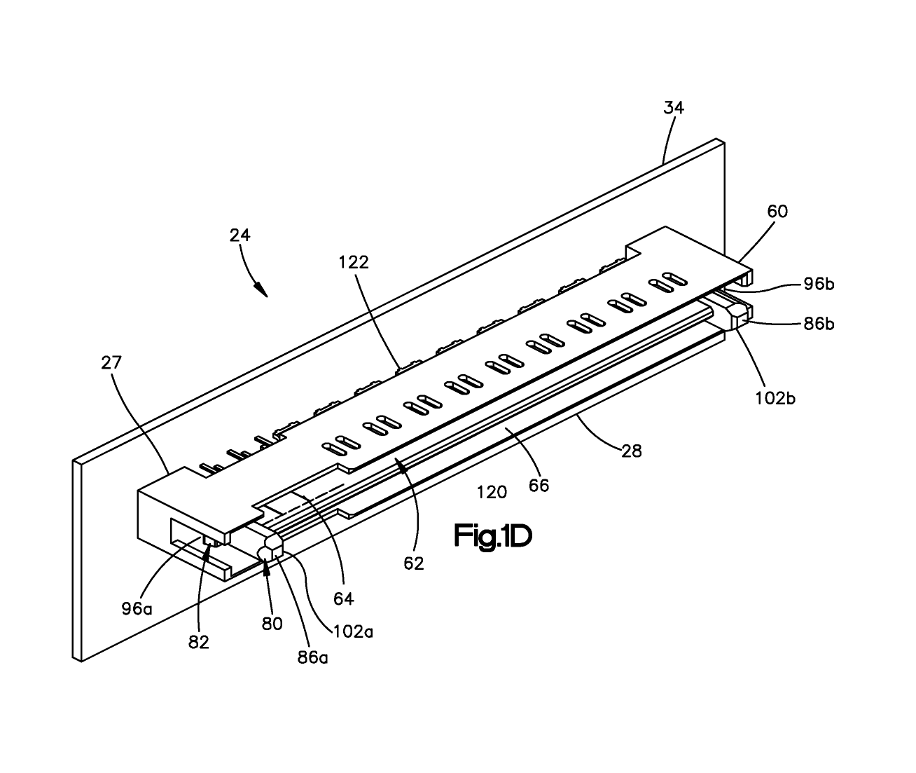

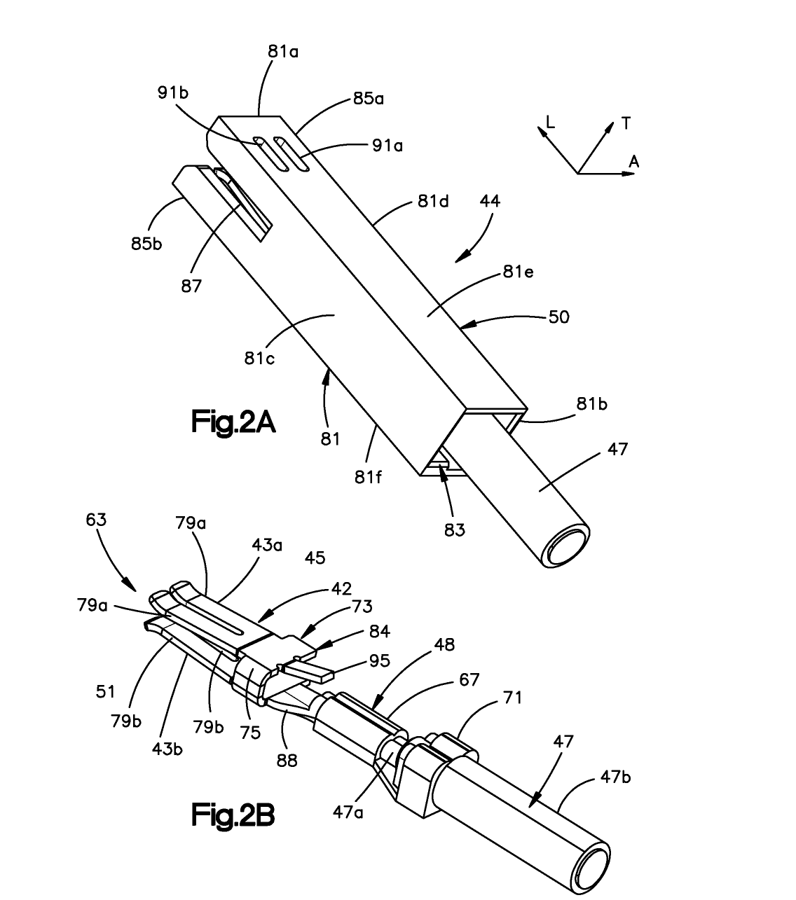

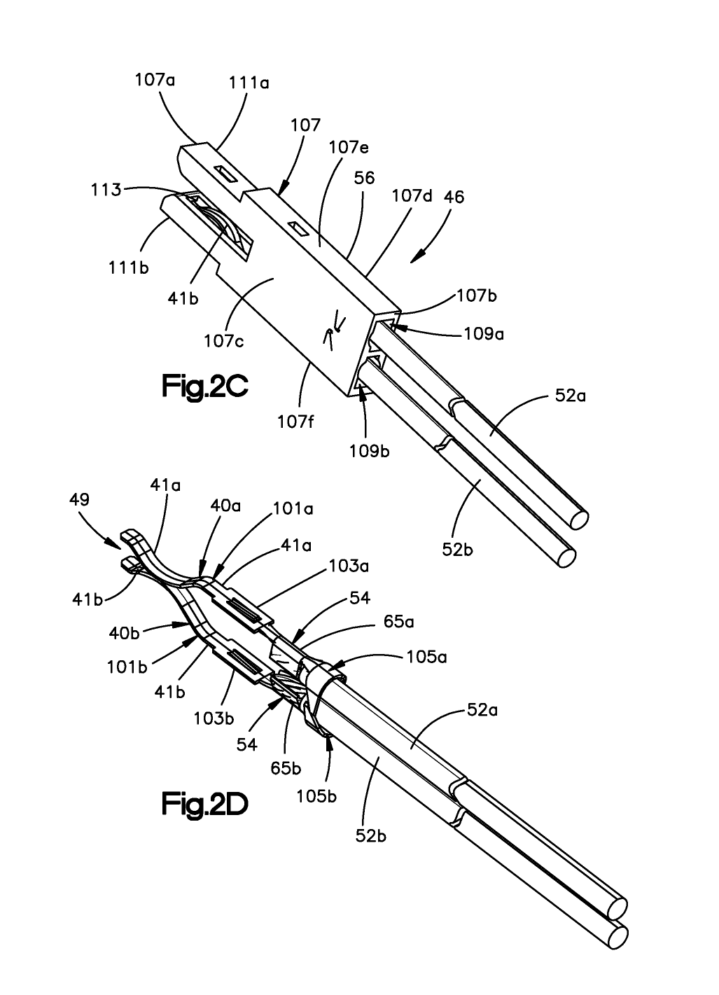

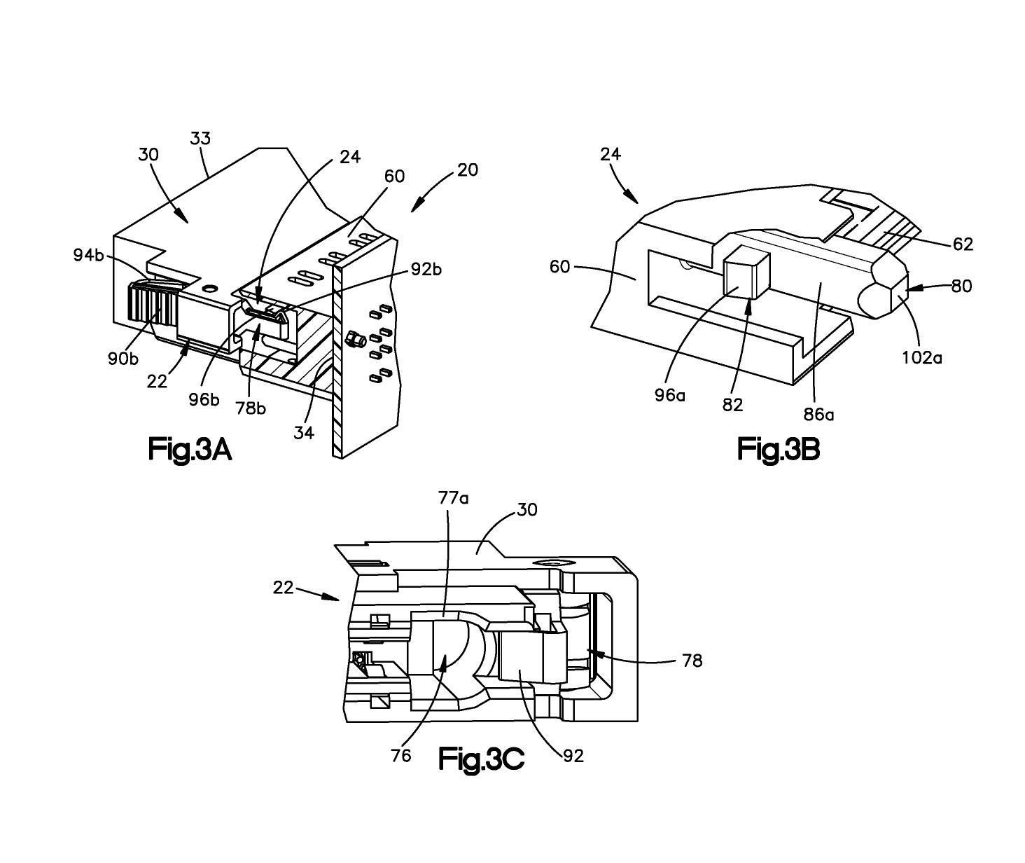

With continuing reference to FIGS. 1A-2D, each of the first plurality of electrical contacts 38 defines a mounting end that is configured to be attached to the first complementary electrical device. For instance, each of the electrical signal contacts 40 defines a mounting end 65 that is configured to be mounted to at least one complementary signal cable 52 so as to define a corresponding plurality of signal contact assemblies 46. Furthermore, each of the electrical power contacts 42 defines a mounting end 67 that is configured to be mounted to at least one complementary power cable 47 so as to define a corresponding plurality of power contact assemblies 44. In accordance with the illustrated embodiment, the mating ends 39 of the first plurality of electrical contacts 38 are disposed proximate to the mating interface 26, and thus proximate to the front end 33a of the housing body 33. Further, in accordance with the illustrated embodiment, the mounting ends of the first plurality of electrical contacts 38 are disposed proximate to the mounting interface 31, and thus proximate to the rear end 33b of the housing body. Accordingly, the mating ends 39 are oriented substantially parallel to the mounting ends of the first plurality of electrical contacts 38, and the first plurality of electrical contacts 38 can be referred to as vertical electrical contacts. It should be appreciated, however, that the first plurality of electrical contacts 38 can be configured as right-angle electrical contacts whereby the mating ends 39 of the first plurality of electrical contacts 38 are oriented substantially perpendicular to each other. For instance, the mating ends 39, and thus the mating interface 26, can be disposed proximate the front end 33a of the housing body 33, and the mounting ends of the first plurality of electrical contacts 38, and thus the mounting interface 31, can be disposed proximate the bottom end 33f of the housing body 33.

Referring now to FIGS. 2A-B, each power contact assembly 44 can include a power cable 47 and at least one power contact 42 that is crimped or otherwise attached to the power cable 47 at an interface 48 between each respective mounting end 67 and a complementary one of the power cables 47, so as to place the electrical power contact 42 and the power cable 47 in electrical communication. For instance, each power cable 47 includes an electrically conductive portion, such as an electrically conductive wire 47a, and an electrically insulative portion, such as an electrically insulative sheath 47b, that surrounds the wire 47a. The mounting ends 67 of the electrical power contacts 42 can be crimped about the wire 47a of the complementary power cable 47 so as to place the power cable 47 in electrical communication with the corresponding electrical power contact 42. Each electrical power contact 42 can further include a strain relief member 71 that is disposed rearward of the mounting end 67, and can be attached to the complementary power cable. For instance, the strain relief member 71 can be crimped about the sheath 47b, such that a majority of a rearwardly directed tensile force applied to the power cable 47 at a location rearward of the strain relief member 71 is absorbed at an interface between the strain relief member and the sheath 47b. Thus, the majority of the rearwardly directed tensile force is isolated from the interface 48 between the mounting end 67 and the wire 47a.

The electrical power contacts 42 can each include a contact body 84 that defines a mating end 45, the mounting end 67 that includes at least one first or upper beam 43a and at least one second or lower beam 43b, a lead portion 73 that is connected between the mating end 45 and the mounting end 67, and the strain relief member 71. In accordance with the illustrated embodiment, the mating end 45, the mounting end 67, the lead portion 73, and the strain relief member 71 are integral and monolithic with each other. The lower beam 43b is spaced from the upper beam 43a along the transverse direction T, such that the upper beam 43a is disposed in the first row 61a and the lower beam 43b is disposed in the second row 61b (see FIG. 1B), and the gap 63 is disposed between the upper and lower beams 43a and 43b. The lead portion 73 can include a strap 75 that is attached between the upper and lower beams 43a and 43b so as to support the upper and lower beams 43a and 43b in the respective first and second rows 61a and 61b. The lead portion 73 can further include a neck 88 that extends from the mounting end 67 to the strap 75, for instance at a location substantially aligned with the lower beam 43b, such that the strap extends from the strap 75 and attaches to both the lower beam 43b and the upper beam 43a.

Each of the upper and lower beams 43a and 43b can be cantilevered from the lead portion 73, and in particular from the strap 75. At least a first portion, such as a rear portion, of the upper beams 43a can extend toward the lower beams 43b, and a second portion, such as a front portion, of the upper beams 43a can extend away from the lower beams 43b. Similarly, at least a first portion, such as a rear portion, of the lower beams 43b can extend toward the upper beams 43a, and a second portion, such as a rear portion, of the lower beams 43b can extend away from the upper beams 43a. The front end of the upper and lower beams 43a and 43b can be split as desired such that each of the upper and lower beams 43a and 43b defines first and second fingers 79a and 79b, respectively, that are spaced from each other along the row direction 51.

Each power contact assembly 44 can include an electrically insulative power contact retainer 50 that supports the power cable 47 and the electrical power contact 42. For instance, the power contact retainer 50 can include a body 81 that defines a front end 81a and an opposed rear end 81b that is spaced from the front end 81a along the longitudinal direction L, first and second opposed sides 81c and 81d that are spaced from each other along the lateral direction A, and a top end 81e and an opposed bottom end 81f that is spaced from the top end 81e along the transverse direction T. The power contact retainer 50 can be supported by the first connector housing 30 such that the front end 81a is disposed proximate to the mating interface 26 of the first electrical connector 22, and the rear end 81b is disposed proximate to the mounting interface 31 of the first electrical connector 22.

The power contact retainer 50 can define an opening 83 that extends forward through the rear end 81b of the body 81 along the longitudinal direction L toward the front end 50a. The power contact retainer 50 further includes upper and lower opposed retainer arms 85a and 85b that extend forward from the body 81, for instance from the front end 81a, along the longitudinal direction L. Each retainer arm 85a and 85b defines a surface that faces the other of the upper and lower retainer arms 85a and 85b, and defines a pocket 87 that extends into the surface along the transverse direction T, such that at least a first portion of the respective upper and lower beams 43a and 43b is at least partially disposed in the respective pockets 87, and a second portion of the respective upper and lower beams 43a and 43b protrudes from the respective surface toward the opposed ones of the upper and lower retainer arms 85a and 85b.

The power contact retainer 50 can further define at least one heat dissipation window that can extend through at least one such as both of the upper and lower retainer arms 85a and 85b along the transverse direction T, and can be aligned with the respective electrical power contact 42, for instance at the mating end 45. In accordance with the illustrated embodiment, the power contact retainer 50 defines first and second heat dissipation windows 91a and 91b that extends through each of the upper and lower retainer arms 85a and 85b along the transverse direction T in at least partial alignment, such as alignment, with the first and second fingers 79a and 79b, respectively. For instance, the first and second heat dissipation windows 91a and 91b that extend through the upper retainer arm 85a can be aligned with the first and second fingers 79a and 79b of the upper beam 43a, and the first and second heat dissipation windows 91a and 91b that extend through the lower retainer arm 85b can be aligned with the first and second fingers 79a and 79b of the lower beam 43b. The first and second windows 91a and 91b that extend through the upper and lower retainer arms 85a and 85b can further be aligned with respective first and second heat dissipation windows 93a and 93b that extend through the housing body 33 of the first connector housing 30 (see FIG. 1B), and can extend for instance through the top and bottom ends 33e and 33f of the housing body 33 along the transverse direction T. Accordingly, during operation, heat disposed at the mating ends 45 of the electrical power contacts 42 can travel through the first and second windows 91a and 91b, and further through the first and second windows 93a and 93b, respectively, and out the first connector housing 30.

Accordance with the illustrated embodiment, the electrical power contacts 42 and power cables 47 can be inserted into the power contact retainer 50 after the mounting end 67 has been attached to the power cable 47. For instance, with continuing reference to FIGS. 2A-B, each of the electrical power contacts 42 can include at least one retention flange 95 that resiliently extends from the contact body 84 rearward along the longitudinal direction L and up along the transverse direction T. For instance, the retention flange 95 can extend from the strap 75, and is configured to mate with a complementary recess disposed in the body 81 of the power contact retainer 50 as the electrical power contacts 42 are inserted forward along the longitudinal direction L through the opening 83 of the rear end 81b of the body 81 until the mating end 45 is disposed in the respective pocket 87, and the complementary power cable 47 extends rearward along the longitudinal direction L out the opening 83. Alternatively, the electrical power contacts 42 can be overmolded by the respective power contact retainers 50. The power contact assemblies 44 can then be installed in the first connector housing 30 by securing the power contact retainers 50 in the housing body 33.

Referring now to FIGS. 2C-D, each signal contact assembly 46 can include at least one signal cable 52 and a corresponding at least one electrical signal contact 40 that is crimped or otherwise secured to the at least one signal cable 52 at an interface 54, so as to place at least one electrical signal contact 40 and the signal cable 52 in electrical communication. Each signal contact assembly 46 can further include a signal contact retainer 56 that supports the at least one signal cable 52 and the corresponding at least one electrical signal contact 40. In accordance with the illustrated embodiment, the signal contact assembly 46 includes a first or upper signal cable 52a and a second or lower signal cable 52b that is spaced from the upper signal cable 52a along the transverse direction T, and a corresponding first or upper electrical signal contact 40a and a second or lower electrical signal contact 40b that is spaced from the upper electrical signal contact 40a along the transverse direction T. The upper electrical signal contact 40a is configured to be mounted to the upper signal cable 52a, and the lower electrical signal contact 40b is configured to be mounted to the lower signal cable 52b. Unless otherwise indicated, reference to the electrical signal contacts 40 and the signal cables 52, and components thereof, refers to both the upper and lower electrical signal contacts 40a and 40b, and the upper and lower signal cables 52a and 52b, and components thereof, respectively.

In accordance with the illustrated embodiment, each of the upper electrical signal contacts 40a can include a respective upper contact body 101a that defines an upper mating end 41a, an upper mounting end 65a, and an upper lead portion 103a that extends between the upper mounting end 65a and the upper mating end 41a. Each of the upper electrical signal contacts 40a can further include an upper strain relief member 105a that extends rearward from the upper mounting end 65a along the longitudinal direction L. Similarly, each of the lower electrical signal contacts 40b can include a respective lower contact body 101b that defines a lower mating end 41b, a lower mounting end 65b, and a lower lead portion 103b that extends between the lower mounting end 65b and the lower mating end 41b. Each of the lower electrical signal contacts 40b can further include lower strain relief member 105b that extends rearward from the lower mounting end 65b along the longitudinal direction L. In accordance with the illustrated embodiment, the mating end 45, the upper and lower mounting ends 65a-b, lead portion 73, and the strain relief member 105 are integral and monolithic with each other.

Each signal cable 52 includes an electrically conductive portion, such as an electrically conductive wire 53a, and an electrically insulative portion, such as an electrically insulative sheath 53b, that surrounds the wire 53a. The mounting ends 65 of the electrical signal contacts 40 can be crimped about the wire 53a of the complementary signal cable 52 so as to place the wire 53a in electrical communication with the respective electrical signal contact 40. The strain relief member 105 can be attached to the complementary signal cable 52. For instance, the strain relief member 105 can be crimped about the sheath 53b, such that a majority of a rearwardly directed tensile force applied to the signal cable 52 at a location rearward of the strain relief member 105 is absorbed at an interface between the strain relief member 105 and the sheath 53b. Thus, the majority of the rearwardly directed tensile force is isolated from the interface 54 between the mounting end 65 and the wire 53a.

The upper electrical signal contacts 40a are spaced from the lower electrical signal contacts 40b along the transverse direction T, such that the upper electrical signal contact 40a is disposed in the first row 61a and the lower electrical signal contact 40b is disposed in the second row 61b (see FIG. 1B), and the gap 63 is disposed between the upper and lower electrical signal contacts 40a and 40b.

Each of the mating ends 41 can be cantilevered from the lead portion 103, such that at least a first portion, such as a rear portion, of the upper mating ends 41a can extend toward the lower mating ends 41b, and a second portion, such as a front portion, of the upper mating ends 41a can extend away from the lower mating ends 41b. Similarly, at least a first portion, such as a rear portion, of the lower mating ends 41b can extend toward the upper mating ends 41a, and a second portion, such as a rear portion, of the lower mating ends 41b can extend away from the upper mating ends 41a.

Each signal contact assembly 46 can include an electrically insulative signal contact retainer 56 that supports one of the upper signal cables 52a and one of the lower signal cables 52b that is aligned with the one of the upper signal cables 52a along the transverse direction T. For instance, the signal contact retainer 56 can include a body 107 that defines a front end 107a and an opposed rear end 107b that is rearwardly spaced from the front end 107a along the longitudinal direction L, first and second opposed sides 107c and 107d that are spaced from each other along the lateral direction A, and a top end 107e and an opposed bottom end 107f that is downwardly spaced from the top end 107e along the transverse direction T. The signal contact retainer 56 can be supported by the first connector housing 30 such that the front end 107a is disposed proximate to the mating interface 26 of the first electrical connector 22, and the rear end 107b is disposed proximate to the mounting interface 31 of the first electrical connector 22.

The signal contact retainer 56 can define at least one opening that extends forward through the rear end 107b of the body 81 along the longitudinal direction L toward the front end 50a. For instance, the signal contact retainer 56 can define an upper opening 109a and a lower opening 109b that is spaced from the upper opening 109a along the transverse direction. The signal contact retainer 56 further includes upper and lower opposed retainer arms 111a and 111b that extend forward from the body 107, for instance from the front end 107a, along the longitudinal direction L. Each retainer arm 111a and 111b defines a surface that faces the other of the retainer arms 111a and 111b, and defines a pocket 113 that extends into the surface along the transverse direction T, such that at least a first portion of the respective upper and lower mating ends 41a and 41b is at least partially disposed in the respective pockets 113, and a second portion of the respective upper and lower mating ends 41a and 41b protrudes from the respective surface toward the opposed ones of the retainer arms 111a and 111b.

Accordance with the illustrated embodiment, the electrical power contacts 42 and power cables 47 can be inserted into the power contact retainer 50 after the mounting end 67 has been attached to the power cable 47. Alternatively, the electrical power contacts 42 can be overmolded by the respective power contact retainers 50. The power contact assemblies 44 can then be installed in the first connector housing 30 by securing the power contact retainers 50 in the housing body 33. It should be further appreciated that the mating ends 39 of the first plurality of electrical contacts 38 can include either or both of the mating ends 45 of the electrical power contacts 42 and the mating ends 41 of the electrical signal contacts 40, and that the mounting ends of the first plurality of electrical contacts 38 can include either or both of the mounting ends 67 of the electrical power contacts 42 and the mounting ends 65 of the plurality of electrical signal contacts 40.

As described above with reference to FIG. 4, the first complementary electrical device can be configured as a substrate 35, such as a printed circuit board. Accordingly, the mounting ends 67 of the electrical power contacts 42 can be mounted to the printed circuit board and placed in electrical communication with electrical traces of the printed circuit board that are configured to carry power, and the mounting ends 65 of the electrical signal contacts 40 can be mounted to the printed circuit board and placed in electrical communication with electrical traces of the printed circuit board that are configured to carry data signals.

Referring now to FIG. 1D, the second electrical connector 24 includes a dielectric or electrically insulative second connector housing 60 and a second plurality of electrical contacts 62 that are supported by the second connector housing 60. For instance, the second plurality of electrical contacts 62 are complementary to the first plurality of electrical contacts 38, and can thus include either or both of a plurality of electrical signal contacts 64 and a plurality of electrical power contacts 66. The second plurality of electrical contacts 62 can define respective mating ends 120 and mounting ends 122 that can be mated with the mating ends 39 of the first plurality of electrical contacts 38 and mounting to the second complementary electrical device, such as the substrate 34, respectively.

In accordance with the illustrated embodiment, the second plurality of electrical contacts 62 are configured to be inserted into the receptacle defined by the front end 33a of the housing body 33, and into the gap 63 defined by the mating ends 39 of the first plurality of electrical contacts 38, thereby placing the first plurality of electrical contacts 38 in electrical communication with the second plurality of electrical contacts 62. For instance, the electrical signal contacts 40 of the first electrical connector 22 can be placed in electrical communication with the electrical signal contacts 64 of the second electrical connector, and the electrical power contacts 42 of the first electrical connector 22 can be placed in electrical communication with the electrical power contacts 66 of the second electrical connector 24

In accordance with the illustrated embodiment, the mating interface 28 and the mounting interface 27 are oriented substantially parallel to each other. Thus, the second electrical connector 24 can be referred to as a vertical electrical connector. Further, the mating ends 120 of the second plurality of electrical contacts 62 are oriented substantially parallel to the mounting ends 122. Thus, the second plurality of electrical contacts 62 can be referred to as vertical electrical contacts. It should be appreciated, however, that the second electrical connector 24 can alternatively be a right-angle connector, whereby the mating interface 28 and the mounting interface 27 are oriented substantially perpendicular to each other as illustrated in FIG. 4. Thus, the second plurality of electrical contacts 62 can alternatively be configured as right-angle electrical contacts whereby the mating ends 120 are oriented substantially perpendicular to the mounting ends 122. Furthermore, while the second plurality of electrical contacts 62 are configured as plug contacts whereby the mating ends 120 are configured to be received by the mating ends 39 of the first plurality of electrical contacts 38, the second plurality of electrical contacts 62 can alternatively be configured as receptacle contacts, whereby the mating ends 120 are configured to receive the mating ends 39 of the first plurality of electrical contacts 38.

Referring now to FIGS. 1A-D and 3A-C, and as described above, the electrical connector assembly 20 can include a guidance assembly 72 and an attachment assembly 74. For instance, the first electrical connector 22 can include at least a first guidance member 76 and a first attachment member 78, and the second electrical connector 24 can include a second guidance member 80 and a second attachment member 82. The first and second guidance members 76 and 80 are configured to engage so as to align the first and second electrical connectors 22 and 24 before the mating ends 39 of the first plurality of electrical contacts 38 mate with the mating ends 120 of the second plurality of electrical contacts 62. The first and second attachment members 78 and 82 are configured to mate with each other so as to secure, such as removably secure, the first connector housing 30 to the second connector housing 60 when the mating ends 39 of the first plurality of electrical contacts 38 mate with the mating ends 120 of the second plurality of electrical contacts 62

For instance, one of the first and second guidance members 76 and 80, for instance the first guidance member 76, can be configured as at least one guide socket, and the other of the first and second guidance members 76 and 80, for instance the second guidance member 80, can be configured as at least one guide pin that is sized to extend into the at least one guide socket. In accordance with the illustrated embodiment, the first electrical connector 22 includes first and second guide sockets 77a and 77b that are supported by the first connector housing 30, and can extend into the housing body 33, for instance rearward along the longitudinal direction L into the front end 33a of the housing body 33. The first guide socket 77a can be disposed between the first plurality of electrical contacts 38, and in particular the electrical signal contacts 40, and the first side 33c of the housing body 33. The second guide socket 77b can be disposed between the first plurality of electrical contacts 38, such as the electrical power contacts 42, and the second side 33d of the housing body 33.

In accordance with the illustrated embodiment, the second electrical connector 24 includes a first guide pin 86a that is carried by the second connector housing 60 and can be disposed between a first side wall of the second connector housing 60 and the second plurality of electrical contacts 62, and a second guide pin 86b that is carried by the second connector housing and can be disposed between a second side wall of the second connector housing 60 and the second plurality of electrical contacts 62. The first and second guide pins 86a-b can be made from a plastic material, and can be integral and monolithic with the second connector housing 60. Thus, the first guide pin 86a is configured to be aligned with the first guide socket 77a, and the second guide pin 86b is configured to be aligned with the second guide socket 77b so as to mate the first electrical connector 22 with the second electrical connector 24. In accordance with the illustrated embodiment, the first and second guide pins 86a and 86b are elongate along the mating direction M, and terminate at respective distal ends 102a and 102b that are outwardly spaced from the front end of the second connector housing 60 along the mating direction M. Thus, the distal ends 102a and 102b are additionally outwardly spaced from the second plurality of electrical contacts 62 with along the mating direction M. As a result, the distal ends 102a and 102b of the first and second guide pins 86a and 86b are configured to be received in the respective first and second guide sockets 77a and 77b before the first plurality of electrical contacts 38 mate with the second plurality of electrical contacts 62.

The first and second guide pins 86a-b can be sized substantially equal to (including slightly less than) the first and second guide sockets 77a-b. Accordingly, when the first and second guide pins 86a-b are received by the first and second guide sockets 77a-b, each of the first and second connector housings 30 and 60 are substantially unable to move relative to the other of the first and second connector housings 30 and 60 along a direction that is perpendicular to the mating direction, such as the lateral direction A and the transverse direction T. Further, the first and second guide sockets 77a-b and the first and second guide pins 86a-b are positioned relative to the first plurality of electrical contacts 38 and the second plurality of electrical contacts 62, respectively, such that the mating ends 120 of the second plurality of electrical contacts 62 are aligned with the gap 63 defined by the mating ends 39 of the first plurality of electrical contacts 38 along the mating direction M. The distal ends 102a and 102b of the first and second guide pins 86a-b can be beveled so as to provide a lead-in to the first and second guide sockets 77a-b.

With continuing reference to FIGS. 1A-D and 3A-C, the first connector housing 30 can include at least a first attachment member 78, such as a pair of first attachment members 78 that are supported by the housing body 33 at opposed sides of the housing body 33 along the lateral direction A, and integral and monolithic with the housing body 33. For instance, the first attachment member 78 can include a first latch member 89a that is pivotally attached to the first connector housing 30 at a first pivot location 114a that is disposed outboard with respect to the first guide socket 77a along the lateral direction A, such that the first guide socket 77a is disposed between the first plurality of electrical contacts 38 and the first pivot location 114a. The first attachment member 78 can further include a second latch member 89b that is pivotally attached to the first connector housing 30 at a second pivot location 114b that is disposed outboard with respect to the second guide socket 77b along the lateral direction A, such that the second guide socket 77b is disposed between the first plurality of electrical contacts 38 and the second pivot location 114b.

The first latch member 89a can include a first latch arm 90a that is pivotally supported by the first connector housing 30 so as to pivot about the first pivot location 114a, which defines a pivot axis that extends along the transverse direction T. The first latch arm 90a is configured to pivot about the first pivot location 114a in a first attachment direction which causes the first latch member 89a to mate with a complementary second attachment member 82 of the second electrical connector 24. Similarly, the second latch member 89b can include a second latch arm 90b that is pivotally supported by the first connector housing 30 so as to pivot about the second pivot location 114b, which defines a pivot axis that extends along the transverse direction T. The second latch arm 90b is configured to pivot about the second pivot location 114b in the first attachment direction which causes the second latch member 89b to mate with a complementary second attachment member 82 of the second electrical connector 24. The first and second latch arms 90a and 90b are further configured to pivot about the respective first and second pivot locations 114a and 114b along a second or detachment direction that is opposite the first direction and configured to disengage the first and second latch members 89a and 89b from the complementary second attachment member 82 of the second electrical connector 24.

The first latch member 89a can further include a first barb 92a that can extend from a first or front end of the first latch arm 90a into an opening of the first connector housing 30, such as a first opening 106a that extends between the top and bottom ends 33e and 33f, respectively, of the housing body 33. The first opening 106a is further open to the first guide socket 77a along the lateral direction A. In accordance with the illustrated embodiment, the first barb 92a projects inwardly along the lateral direction A from the first latch arm 90a. The first latch arm 90a can be laterally outwardly disposed with respect to the first guide socket 77a. The first latch member 89a can further carry a spring member, such as a first spring member 94a, that extends from a second or the rear end of the first latch arm 90a. Thus, the first pivot location 114a is disposed between the first barb 92a and the first spring member 94a. The first spring member 94a is disposed outward with respect to the first side 33c of the housing body 33, and can be configured as a resilient and flexible arm that has a portion that is spaced from the first latch arm 90a along the lateral direction A.

The first spring member 94a is configured to abut and resiliently compress against the housing body 33, for instance at the first side 33c, as the first latch arm 90a pivots in the detachment direction, which causes the rear end of the first latch arm 90a to move in a first direction, such as inward toward the first plurality of electrical contacts 38, and causes the front end of the first latch arm 90a, and thus the first barb 92a to move in an opposed second direction, such as outward away from the first plurality of electrical contacts 38. It should be appreciated that when the first spring member 94a is compressed against the housing body 33, the first spring member 94a applies a biasing force to the rear end of the first latch arm 90a that biases the first latch arm 90a to move in the attachment direction, such that the rear end of the first latch arm 90a moves in the second direction, for instance away from the first plurality of electrical contacts 38, and the front end of the first latch arm 90a, and thus the first barb 92a moves in the first direction, for instance toward the first plurality of electrical contacts 38.

Similarly, the second latch member 89b can further include a second barb 92b that can extend from a first or front end of the second latch arm 90b into an opening, such as a second opening 106b that extends between the top and bottom ends 33e and 33f, respectively, of the housing body 33. The second opening 106b is further open to the second guide socket 77b along the lateral direction A. In accordance with the illustrated embodiment, the second barb 92b projects inwardly along the lateral direction A from the second latch arm 90b. The second latch arm 90b can be laterally outwardly disposed with respect to the second guide socket 77b. The second latch member 89b can further carry a spring member, such as a second spring member 94b, that extends from a second or rear end of the second latch arm 90b. Thus, the second pivot location 114b is disposed between the second barb 92b and the second spring member 94b. The second spring member 94b is disposed outward with respect to the second side 33d of the housing body 33, and can be configured as a resilient and flexible arm that has a portion that is spaced from the second latch arm 90b along the lateral direction A.

The second spring member 94b is configured to abut and resiliently compress against the housing body 33, for instance at the second side 33d, as the second latch arm 90b pivots in the detachment direction, which causes the rear end of the second latch arm 90b to move in a first direction, such as inward toward the first plurality of electrical contacts 38, and causes the front end of the second latch arm 90b, and thus the second barb 92b to move in an opposed second direction, such as outward away from the first plurality of electrical contacts 38. It should be appreciated that when the second spring member 94b is compressed against the housing body 33, the second spring member 94b applies a biasing force to the rear end of the second latch arm 90b that biases the second latch arm 90b to move in the attachment direction, such that the rear end of the second latch arm 90b moves in the second direction, for instance away from the first plurality of electrical contacts 38, and the front end of the second latch arm 90b, and thus the second barb 92b moves in the first direction, for instance toward the first plurality of electrical contacts 38.

The second attachment member 82 can be carried by a corresponding one of the second guidance member 80, and is configured to releasably secure the first attachment member 78 when the first and second electrical connectors 22 and 24 are mated. For instance, the second attachment member 82 can include a latch member configured as a first projection 96a that is carried by the first guide pin 86a, and can extend out from the first guide pin 86a along a direction that is angularly offset, such as substantially perpendicular, with respect to the mating direction M. In accordance with the illustrated embodiment, the first projection 96a extends from the first guide pin 86a along a direction away from the second plurality of electrical contacts 62, such that the first guide pin 86a is disposed between the first projection 96a and the second plurality of electrical contacts 62. The second attachment member 82 can include a second latch member configured as a second projection 96b that is carried by the second guide pin 96b, and can extend out from the second guide pin 86b along a direction that is angularly offset, such as substantially perpendicular, with respect to the mating direction M. In accordance with the illustrated embodiment, the second projection 96b extends from the second guide pin 86b along a direction away from the second plurality of electrical contacts 62, such that the second guide pin 86b is disposed between the second projection 96b and the second plurality of electrical contacts 62. The first and second projections 96a-b can be made from a plastic material, and can be integral and monolithic with the first and second guide pins 86a-b, and can thus further be integral and monolithic with the second connector housing 60.

During operation, the first and second guide pins 86a-b are received in the first and second guide sockets 77a-b, respectively, before the first and second pluralities of electrical contacts 38 and 62, respectively, mate with each other. The first and second pluralities of electrical contacts 38 and 62, respectively, are mated with each other when the first and second guide pins 86a-b are fully seated in the respective first and second guide sockets 77a-b. As the first and second guide pins 86a-b are received in the respective first and second guide sockets 77a-b, the first and second projections 96a-b extend from the respective first and second guide sockets 77a-b into the first and second openings 106a-b. The first and second barbs 92a-b, which can be at least partially disposed in the first and second openings 106a-b, each of which can define a beveled front surface, engage the projections 96a-b, and ride along and past the respective first and second projections 96a-b, which causes the first and second spring members 94a-b to compress against the housing body 33, until the first and second barbs 92a-b travel behind the complementary first and second projections 96a-b. The first and second spring members 94a-b apply a biasing force that biases the first and second latch members 89a-b to pivot about the respective first and second pivot locations 114a-b along the attachment direction, which causes the first and second barbs 92a-b to move in the first direction, such as toward the respective first plurality of electrical contacts 38, which causes a rear end of the first and second barbs 92a-b to be positioned in alignment with the complementary first and second projections 96a-b. As a result, after the first and second electrical connectors 22 and 24 are mated, the first and second barbs 92a-b interfere with the respective first and second projections 96a-b so as to prevent each of the first and second electrical connectors 22 and 24 from moving relative to the other of the first and second electrical connectors 22 and 24 along a direction opposite the mating direction so as to unmate the first and second electrical connectors 22 and 24 from each other.

A laterally inward force can be applied to the rear ends of one or both of the first and second latch arms 90a-b that causes the first and second latch members 94a-b move along the detachment direction about the respective first and second pivot locations 114a-b. Thus, the rear ends of the first and second latch arms 90a-b move toward the housing body, which in turn compresses the corresponding first and second spring members 94a-b against the housing body, and causes the front ends of the first and second latch arms 90a-b and first and second barbs 92a-b to move away from the first plurality of electrical contacts 38, and thus away from the complementary first and second projections 96a-b until the first and second barbs 92a-b are out of alignment with the first and second projections 96a-b, at which point either or both of the first and second electrical connectors 22 and 24 can be moved away from the other of the first and second electrical connectors 22 and 24, so as to unmate the first and second electrical connectors 22 and 24.

It should be appreciated that while the first guidance member 76 of the first electrical connector 22 is configured as at least one socket and the second guidance member 80 of the second electrical connector 24 is configured as at least one guide pin as described above, it should be appreciated that the first guidance member 76 can alternatively be configured as at least one guide pin constructed as described above, and the second guidance member 80 can be configured as at least one guide socket constructed as described above. Furthermore, while the first attachment member 78 of the first electrical connector 22 is configured as at least one latch member and the second attachment member 82 of the second electrical connector 24 is configured as at least one projection as described above, it should be appreciated that the first attachment member 78 can alternatively be configured as at least one projection that is constructed as described above, and the second attachment member 82 can be configured as at least one latch member constructed as described above.

The embodiments described in connection with the illustrated embodiments have been presented by way of illustration, and the present invention is therefore not intended to be limited to the disclosed embodiments. Accordingly, those skilled in the art will realize that the invention is intended to encompass all modifications and alternative arrangements included within the spirit and scope of the invention, for instance as set forth by the appended claims

What is claimed:

1. An electrical connector configured to mate with a complementary electrical connector, the electrical connector comprising:
a connector housing and a plurality of electrical contacts that are supported by the connector housing, the plurality of electrical contacts configured to mate with electrical contacts of the complementary electrical connector at a mating interface;
a guidance member that is configured to engage a complementary guidance member of the complementary electrical connector so as to align the electrical connector with the complementary electrical connector; and
a latch member carried by the guidance member, wherein the latch member is configured to engage a latch member of the complementary electrical connector so as to secure the electrical connector and the complementary electrical connector when the electrical connector is mated with the complementary electrical connector.

2. The electrical connector as recited in claim 1, wherein the latch member is configured to releasably secure the electrical connector and the complementary electrical connector when mated.

3. The electrical connector as recited in claim 1, wherein the guidance member comprises a guide pin that projects forward from a front end of the connector housing.

4. The electrical connector as recited in claim 3, wherein the latch member comprises a projection that extends out from the guide pin.

5. The electrical connector as recited in claim 4, wherein the projection extends from the guide pin along a direction away from the plurality of electrical contacts.

6. The electrical connector as recited in claim 4, wherein the electrical connector is configured to mate with the complementary electrical connector along a mating direction, the guide pin is elongate in the mating direction, and the latch member extends out from the guide pin along a direction that is substantially perpendicular to the mating direction.

7. The electrical connector as recited in claim 1, wherein the electrical contacts include signal contacts and power contacts

8. An electrical connector assembly comprising:
a first electrical connector including a first connector housing and a first plurality of electrical contacts supported by the first connector housing, a first guidance member carried by the first connector housing, and at least one latch member carried by the first connector housing; and
a second electrical connector configured to mate with the first electrical connector, the second electrical connector including a second connector housing and a second plurality of electrical contacts that are supported by the second connector housing, a second guidance member carried by the connector housing, and a latch member carried by the second guidance member,
wherein the first and second guidance members are configured to mate with each other so as to align the first and second electrical connectors to be mated, and the at least one latch member of the first electrical connector is configured to mate with the latch member of the second electrical connector so as to secure the first electrical connector to the second electrical connectors when the first and second electrical connectors are mated to each other along a mating direction.

9. The electrical connector assembly as recited in claim 8, wherein the first guidance member comprises a socket that is carried by the first connector housing, and the second guidance member comprises a guide pin configured to be received in the socket.

10. The electrical connector assembly as recited in claim 9, wherein the guide pin defines a distal end that is outwardly spaced from the second connector housing.

11. The electrical connector assembly as recited in claim 9, wherein the latch member of the second electrical connector comprises a projection that extends out from the guide pin.

12. The electrical connector as recited in claim 11, wherein the guide pin is elongate along the mating direction, and projection extends out from the guide pin along a second direction that is substantially perpendicular to the mating direction.

13. The electrical connector as recited in claim 11, wherein the guide pin is disposed between the second plurality of electrical contacts and the projection.

14. The electrical connector as recited in claim 13, wherein the projection extends from the guide pin along a direction away from the second plurality of electrical contacts.

15. The electrical connector as recited in claim 11, wherein the at least one latch member of the first electrical connector includes a latch arm that is pivotally attached to the connector housing at a pivot location, and a barb that is carried by the latch arm and disposed in an opening that is defined by the connector housing, wherein the opening is open to the guide socket along a direction that is substantially perpendicular to the mating direction.

16. The electrical connector as recited in claim 15, wherein the projection extends into the opening when the guidance pin is disposed in the socket, such that the barb engages the projection so as to prevent each of the first and second electrical connectors from moving along a direction opposite the mating direction with respect to the other of the first and second electrical connectors.

17. An electrical connector configured to mate with a complementary electrical connector along a mating direction, the electrical connector comprising:
a connector housing and a plurality of electrical contacts that are supported by the connector housing, the plurality of electrical contacts configured to mate with electrical contacts of the complementary electrical connector at a mating interface;
a guide socket that is supported by the connector housing and configured to receive a guide pin of the complementary electrical connector along the mating direction so as to align the electrical connector with the complementary electrical connector; and
a latch member including a latch arm that is pivotally attached to the connector housing at a pivot location, and a barb that is carried by the latch arm and disposed in an opening that is defined by the connector housing, wherein the opening is open to the guide socket along a direction that is substantially perpendicular to the mating direction, such that the barb is configured to engage a latch member of the complementary electrical connector as the guide socket receives the guide pin.
